(19) United States
(12) Patent Application Publication
(10) Pub. No.: US 2021/0017311 A1
(43) Pub. Date: Jan. 21, 2021

(54) SILICON-TERMINATED TELECHELIC POLYOLEFIN COMPOSITIONS AND PROCESSES FOR PREPARING THE SAME

(71) Applicants: Dow Silicones Corporation, Midland, MI (US); Rohm and Haas Electronic Materials LLC, Marlborough, MA (US); Dow Global Technologies LLC, Midland, MI (US)

(72) Inventors: Jongwook Choi, Midland, MI (US); David D. Devore, Midland, MI (US); Robert David Grigg, Midland, MI (US); Phillip D. Hustad, St. Paul, MN (US); Jaclyn Murphy, Ashland, MA (US); Mark E. Ondari, Freeland, MI (US); Jordan Reddel, Midland, MI (US); Lixin Sun, Sugar Land, TX (US)

(21) Appl. No.: 16/982,503

(22) PCT Filed: Mar. 18, 2019
(86) PCT No.: PCT/US2019/022793

§ 371 Date: Sep. 18, 2020

Related U.S. Application Data
(60) Provisional application No. 62/644,808, filed on Mar. 19, 2018.

(51) Int. Cl. C08F 210/16; C08F 8/42; C08F 8/12; C08F 4/659

(52) U.S. Cl. CPC C08F 210/16; C08F 8/42; C08F 4/65908; C08F 4/65912; C08F 8/12

(57) ABSTRACT

The present disclosure is directed to a silicon-terminated telechelic polyolefin composition comprising a compound of formula (I). Embodiments related to a process for preparing the silicon-terminated telechelic polyolefin composition comprising a compound of formula (I), the process comprising combining starting materials comprising (A) a silicon-terminated organo-metal compound and (B) a silicon-based functionalization agent, thereby obtaining a product comprising the silicon-terminated telechelic polyolefin composition. In further embodiments, the starting materials of the process may further comprise (C) a nitrogen containing heterocycle. In further embodiments, the starting materials of the process may further comprise (D) a solvent.

### CROSS-REFERENCE TO RELATED APPLICATIONS

The present application claims the benefit of priority to U.S. provisional patent application No. 62/644,808, filed on Mar. 19, 2018, and is hereby incorporated by reference in its entirety.

### FIELD

Embodiments relate to telechelic polyolefin compositions comprising at least one silicon atom at both terminal ends and processes for preparing the same.

### BACKGROUND

In recent years, advances in polymer design have been seen with the use of compositions capable of chain shuttling and/or chain transfer. For example, chain shuttling agents having reversible or partial reversible chain transfer ability with transition metal catalysts have enabled the production of novel olefin block copolymers (OBCs). Typical compositions capable of chain shuttling and/or chain transfer are simple metal alkyls, such as diethyl zinc and triethyl aluminum. Upon polymerization of a chain shuttling agent, polymeryl-metal intermediates can be produced, including but not limited to compounds having the formula Q2Zn or Q₃Al, with Q being an oligo- or polymeric substituent. These polymeryl-metal intermediates can enable the synthesis of novel end-functional polyolefins, including novel silicon-terminated telechelic polyolefins.

### SUMMARY

In certain embodiments, the present disclosure relates to a silicon-terminated telechelic polyolefin composition comprising a compound of formula (I):

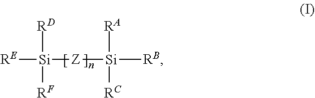

wherein:

Z is a substituted or unsubstituted divalent C₁ to C₂₀ hydrocarbyl group that is linear, branched, or cyclic;

subscript n is a number from 13 to 100,000;

R^{A}, R^{B}, R^{C}, R^{D}, R^{E}, and R^{F} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

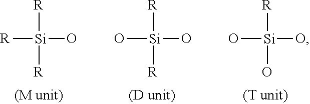

wherein each R is independently a hydrogen atom, a substituted or unsubstituted C₁ to C₁₀ monovalent hydrocarbyl group that is linear, branched, or cyclic, a vinyl group, or an alkoxy group;

two or all three of R^{A}, R^{B}, and R^{C} may optionally be bonded together to form a ring structure when two or all three of R^{A}, R^{B}, and R^{C} are each independently one or more siloxy units selected from D and T units; and

two or all three of R^{D}, R^{E}, and R^{F} may optionally be bonded together to form a ring structure when two or all three of R^{D}, R^{E}, and R^{F} are each independently one or more siloxy units selected from D and T units.

In certain embodiments, the present disclosure relates to a process for preparing the silicon-terminated telechelic polyolefin composition, the process comprising combining starting materials comprising (A) a silicon-terminated organo-metal compound and (B) a silicon-based functionalization agent, thereby obtaining a product comprising the silicon-terminated telechelic polyolefin composition. In further embodiments, the starting materials of the process may further comprise (C) a nitrogen containing heterocycle. In further embodiments, the starting materials of the process may further comprise (D) a solvent.

### BRIEF DESCRIPTION OF DRAWINGS

FIGS. 1, 3, and 5 provide NMR spectra for the examples.

FIGS. 2, 4, and 6 provide GCMS spectra for the examples.

### DETAILED DESCRIPTION

The present disclosure is directed to a silicon-terminated telechelic polyolefin composition comprising a compound of formula (I) and a process for preparing the same. The process comprises 1) combining starting materials comprising (A) a silicon-terminated organo-metal compound and (B) a silicon-based functionalization agent, thereby obtaining a product comprising the silicon-terminated telechelic polyolefin composition. In further embodiments, the starting materials of the process may further comprise (C) a nitrogen containing heterocycle. In further embodiments, the starting materials of the process may further comprise (D) a solvent.

Step 1) of combining the starting materials may be performed by any suitable means, such as mixing at a temperature of 50° C. to 200° C., alternatively 100° C. to 120° C., at ambient pressure. Heating may be performed under inert, dry conditions. In certain embodiments, step 1) of combining the starting materials may be performed for a duration of 30 minutes to 20 hours, alternatively 1 hour to 10 hours. In further embodiments, step 1) of combining the starting materials may be performed by solution processing (i.e., dissolving and/or dispersing the starting materials in a (D) solvent and heating) or melt extrusion (e.g., when a (D) solvent is not used or is removed during processing).

The process may optionally further comprise one or more additional steps. For example, the process may further comprise: 2) recovering the silicon-terminated telechelic polyolefin composition. Recovering may be performed by any suitable means, such as precipitation and filtration, thereby removing unwanted materials.

The amount of each starting material depends on various factors, including the specific selection of each starting material. However, in certain embodiments, a molar excess of starting material (B) may be used per molar equivalent of starting material (A). For example, the amount of starting material (B) may be 2 to 3 molar equivalents per molar equivalent of starting material (A). If starting material (C) is used, the amount of starting material (C) may be 2 molar equivalents per molar equivalent of starting material (A).

The amount of (D) solvent will depend on various factors, including the selection of starting materials (A), (B), and (C). However, the amount of (D) solvent may be 65% to 95% based on combined weights of all starting materials used in step 1).

### (A) Silicon-Terminated Organo-Metal Compound

Starting material (A) of the present process may be a silicon-terminated organo-metal compound having the formula (II) or (III):

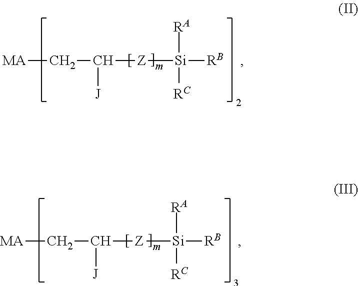

wherein:

MA is a divalent metal selected from the group consisting of Zn, Mg, and Ca;

MB is a trivalent metal selected from the group consisting of Al, B, and Ga;

each Z is independently a substituted or unsubstituted divalent C₁ to C₂₀ hydrocarbyl group that is linear, branched, or cyclic;

each subscript m is a number from 1 to 100,000;

each J is independently a hydrogen atom or a monovalent C₁ to C₂₀ hydrocarbyl group;

each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

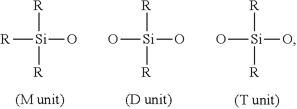

wherein each R is independently a hydrogen atom, a substituted or unsubstituted C₁ to C₁₀ monovalent hydrocarbyl group that is linear, branched, or cyclic, a vinyl group, or an alkoxy group;

two or all three of R^{A}, R^{B}, and R^{C} of one silicon atom may optionally be bonded together to form a ring structure when two or all three of R^{A}, R^{B}, and R^{C} of one silicon atom are each independently one or more siloxy units selected from D and T units.

In certain embodiments, each subscript m of formulas (II) and (III) is a number from 1 to 75,000, from 1 to 50,000, from 1 to 25,000, from 1 to 10,000, from 1 to 5,000, from 1 to 2,500, and/or from 1 to 1,000. In further embodiments of formulas (II) and (III), each Z is independently an unsubstituted divalent C₁ to C₂₀ hydrocarbyl group that is linear or branched.

In certain embodiments of formula (II), MA is Zn. In certain embodiments of formula (II), MB is Al. In further embodiments of formulas (II) and (II), each J is an ethyl group. In further embodiments of formulas (II) and (II), each J is a hydrogen atom. In certain embodiments of formulas (II) and (III), at least one of R^{A}, R^{B}, and R^{C} of each silicon atom is a hydrogen atom or a vinyl group. In further embodiments of formulas (II) and (II), at least two of R^{A}, R^{B}, and R^{C} of each silicon atom are each a methyl group.

Prior to the present process, the silicon-terminated organo-metal compound may be prepared according to the disclosures of co-pending U.S. Patent Application Nos. 62/644,654 and 62/644,664.

For example, in certain embodiments, prior to step 1) of the present process, the silicon-terminated organo-metal compound may be prepared by the process of (1a), wherein the process of (1a) comprises combining starting materials comprising: (a) a vinyl-terminated silicon-based compound, (b) a chain shuttling agent, (c) a procatalyst, (d) an activator, (e) an optional solvent, and (f) an optional scavenger, thereby obtaining a product comprising the silicon-terminated organo-metal compound. The process of (1a) may be conducted at a temperature of from 10° C. to 100° C., or from 20° C. to 60° C., or from 20° C. to 30° C., at ambient pressure, for a duration of from 30 minutes to 20 hours, or from 1 hour to 10 hours, or from 1 hour to 5 hours, or from 1 hour to 3 hours.

In further embodiments, prior to step 1 of the present process, the silicon terminated organo-metal compound may be prepared by the process of (1b), wherein the process of (1b) comprises combining starting materials at an elevated temperature, the starting materials comprising: (a) a vinyl-terminated silicon-based compound, (b) a chain shuttling agent, and an (e) optional solvent. The process of (1b) may be conducted at a temperature of 60° C. to 200° C., or from 80° C. to 180° C., or from 100° C. to 150° C. The process of (1b) may be conducted for a duration of from 30 minutes to 200 hours, or from 30 minutes to 100 hours, or from 30 minutes to 50 hours, or from 30 minutes to 25 hours, or from 30 minutes to 10 hours, or from 30 minutes to 5 hours, or from 30 minutes to 3 hours.

In certain embodiments, the (a) vinyl-terminated silicon-based compound may have the formula (IV):

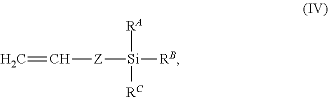

wherein:

Z is a substituted or unsubstituted divalent C₁ to C₂₀ hydrocarbyl group that is linear, branched, or cyclic;

R^{A}, R^{B}, and R^{C} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

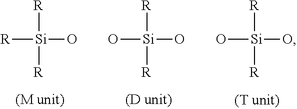

wherein each R is independently a hydrogen atom, a substituted or unsubstituted C₁ to C₁₀ monovalent hydrocarbyl group that is linear, branched, or cyclic, a vinyl group, or an alkoxy group; and

two or all three of R^{A}, R^{B}, and R^{C} may optionally be bonded together to form a ring structure when two or all three of R^{A}, R^{B}, and R^{C} are each independently one or more siloxy units selected from D and T units.

In certain embodiments of formula (IV), at least one of R^{A}, R^{B}, and R^{C} is a hydrogen atom or a vinyl group. In further embodiments of formulas (IV), at least two of R^{A}, R^{B}, and R^{C} are each a methyl group. In certain embodiments of formula (IV), Z is independently an unsubstituted divalent C₁ to C₂₀ hydrocarbyl group that is linear or branched.

In certain embodiments, the (b) chain shuttling agent may have the formula XₓM, where M may be a metal atom from group 1, 2, 12, or 13 of the Period Table of Elements, each X is independently a hydrocarbyl group of 1 to 20 carbon atoms, and subscript x is 1 to the maximum valence of the metal selected for M. In certain embodiments, M may be a divalent metal, including but not limited to Zn, Mg, and Ca. In certain embodiments, M may be a trivalent metal, including but not limited to Al, B, and Ga. In further embodiments, M may be either Zn or Al. The monovalent hydrocarbyl group of 1 to 20 carbon atoms may be alkyl group exemplified by ethyl, propyl, octyl, and combinations thereof. Suitable chain shuttling agents include those disclosed in U.S. Pat. Nos. 7,858,706 and 8,053,529, which are hereby incorporated by reference.

In certain embodiments, the (c) procatalyst may be any compound or combination of compounds capable of, when combined with an activator, polymerization of unsaturated monomers. Suitable procatalysts include but are not limited to those disclosed in WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,355,089 B2, 8,058,373 B2, and 8,785,554 B2, where are hereby incorporated by reference.

Suitable procatalysts include but are not limited to the following structures labeled as procatalysts (A1) to (A8):

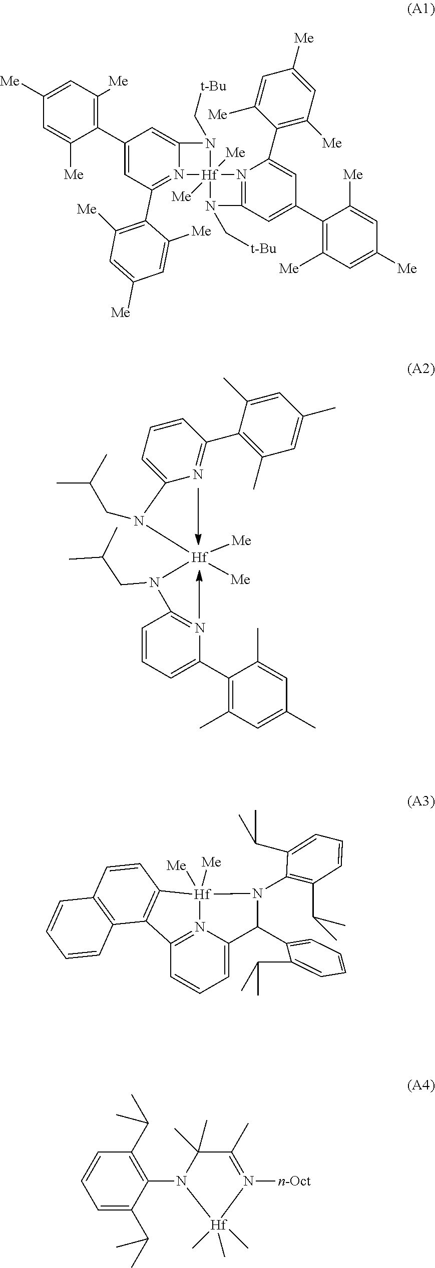

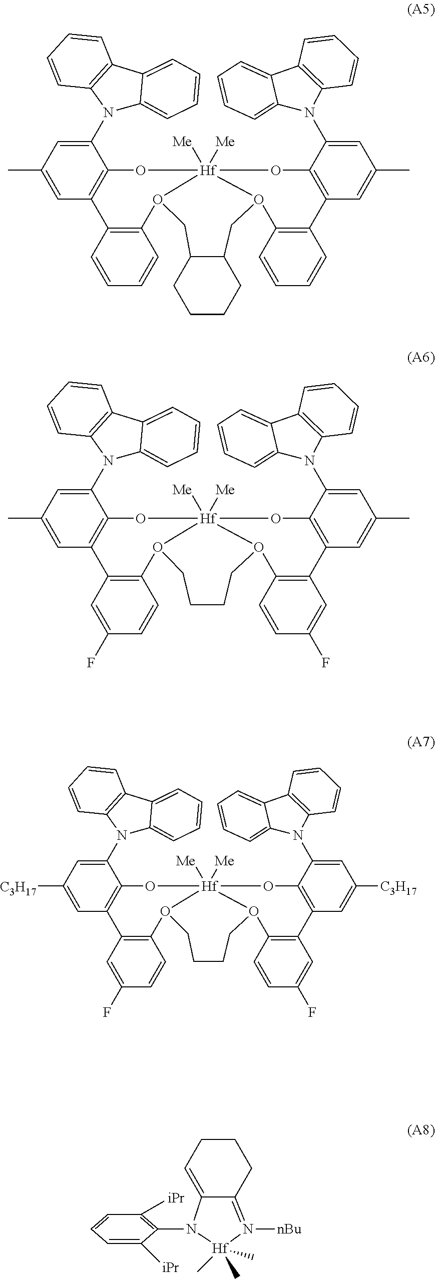

Procatalysts (A1) and (A2) may be prepared according to the teachings of WO 2017/173080 A1 or by methods known in the art. Procatalyst (A3) may be prepared according to the teachings of WO 03/40195 and U.S. Pat. No. 6,953,764 B2 or by methods known in the art. Procatalyst (A4) may be prepared according to the teachings of Macromolecules (Washington, D.C., United States), 43(19), 7903-7904 (2010) or by methods known in the art. Procatalysts (A5), (A6), and (A7) may be prepared according to the teachings of WO 2018/170138 A1 or by methods known in the art. Procatalyst (A8) may be prepared according to the teachings of WO 2011/102989 A1 or by methods known in the art.

In certain embodiments, the (d) activator may be any compound or combination of compounds capable of activating a procatalyst to form an active catalyst composition or system. Suitable activators include but are not limited to Brønsted acids, Lewis acids, carbocationic species, or any activator known in the art, including but limited to those disclosed in WO 2005/090427 and U.S. Pat. No. 8,501,885 B2. In exemplary embodiments of the present disclosure, the co-catalyst is [(C₁₆₋₁₈H₃₃₋₃₇)₂CH₃NH] tetrakis(pentafluorophenyl)borate salt.

In certain embodiments, the (e) optional solvent may be any disclosed herein and below.

In further embodiments, the silicon-terminated organo-metal compound prepared by the process of (1a) or (1b) may be followed by a subsequent polymerization step. Specifically, the silicon-terminated organo-metal compound prepared by the process of (1a) or (1b) may be combined with at least one olefin monomer, a procatalyst as defined herein, an activator as defined herein, and optional materials, such as solvents and/or scavengers, under polymerization process conditions known in the art, including but not limited to those disclosed in U.S. Pat. Nos. 7,858,706 and 8,053,529. Such a polymerization step essentially increases the subscript n in the formula (I) and the subscript m in formulas (II) and (II).

Suitable monomers for the polymerization step include any addition polymerizable monomer, generally any olefin or diolefin monomer. Suitable monomers can be linear, branched, acyclic, cyclic, substituted, or unsubstituted. In one aspect, the olefin can be any α-olefin, including, for example, ethylene and at least one different copolymerizable comonomer, propylene and at least one different copolymerizable comonomer having from 4 to 20 carbons, or 4-methyl-1-pentene and at least one different copolymerizable comonomer having from 4 to 20 carbons. Examples of suitable monomers include, but are not limited to, straight-chain or branched α-olefins having from 2 to 30 carbon atoms, from 2 to 20 carbon atoms, or from 2 to 12 carbon atoms. Specific examples of suitable monomers include, but are not limited to, ethylene, propylene, 1-butene, 1-pentene, 3-methyl-1-butene, 1-hexane, 4-methyl-1-pentene, 3-methyl-1-pentene, 1-octene, 1-decene, 1-dodecene, 1-tetradecene, 1-hexadecene, 1-octadecene, and 1-eicosene. Suitable monomers also include cycloolefins having from 3 to 30, from 3 to 20 carbon atoms, or from 3 to 12 carbon atoms. Examples of cycloolefins that can be used include, but are not limited to, cyclopentene, cycloheptene, norbomene, 5-methyl-2-norbomene, tetracyclododecene, and 2-methyl-1,4,5,8-dimethano-1,2,3,4,4a,5,8,8a-octahydronaphthalene. Suitable monomers also include di- and poly-olefins having from 3 to 30, from 3 to 20 carbon atoms, or from 3 to 12 carbon atoms. Examples of di- and poly-olefins that can be used include, but are not limited to, butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidene norbomene, vinyl norbomene, dicyclopentadiene, 7-methyl-1,6-octadiene, 4-ethylidene-8-methyl-1,7-nonadiene, and 5,9-dimethyl-1,4,8-decatriene. In a further aspect, aromatic vinyl compounds also constitute suitable monomers for preparing the copolymers disclosed here, examples of which include, but are not limited to, mono- or poly-alkylstyrenes (including styrene, o-methylstyrene, m-methylstyrene, p-methylstyrene, o,p-dimethylstyrene, o-ethylstyrene, m-ethylstyrene and p-ethylstyrene), and functional group-containing derivatives, such as methoxystyrene, ethoxystyrene, vinylbenzoic acid, methyl vinylbenzoate, vinylbenzyl acetate, hydroxystyrene, o-chlorostyrene, p-chlorostyrene, divinylbenzene, 3-phenylpropene, 4-phenylpropene and a-methylstyrene, vinylchloride, 1,2-difluoroethylene, 1,2-dichloroethylene, tetrafluoroethylene, and 3,3,3-trifluoro-1-propene, provided the monomer is polymerizable under the conditions employed.

Silicon-terminated organo-metal compounds prepared as described above followed by a polymerization step include but are not limited to silicon-terminated di-polyethylene zinc, silicon-terminated di-poly(ethylene/octene) zinc, and mixtures thereof. In certain embodiments, the starting material (A) silicon-terminated organo-metal compound may be silicon-terminated di-polyethylene zinc. In further embodiments, the starting material (A) silicon-terminated organo-metal compound may be silicon-terminated di-poly(ethylene/octene) zinc.

In certain embodiments, the starting material (A) silicon-terminated organo-metal compound may have an Mn from 1,000 g/mol to 1,000,000 g/mol, or from 1,000 g/mol to 500,000 g/mol, or from 1,000 g/mol to 250,000 g/mol, or from 1,000 g/mol to 100,000 g/mol, or from 1,000 g/mol to 50,000 g/mol, or from 3,000 g/mol to 30,000 g/mol according to methods described herein or known in the art.

As described below in the examples, the silicon-terminated organo-metal compound may also be prepared by combining starting materials comprising 6-bromo-1-hexene, magnesium, THF, and chlorodimethylsilane to form hex-5-en-1-yldimethylsilane, followed by combining hex-5-en-1-yldimethylsilane, triethylborane, a borane-dimethylsulfide complex, and diethyl zinc to form the silicon terminated organo-metal compound.

The silicon-terminated organo-metal compound may also be prepared by combining starting materials comprising triethylborane, a borane-dimethylsulfide complex, diethyl zinc, and 7-octenyldimethylsilane to form the silicon-terminated organo-metal compound.

The silicon-terminated organo-metal compound may include any or all embodiments disclosed herein.

### (B) Silicon-Based Functionalization Agent

Starting material (B) of the present process is a silicon-based functionalization agent having the formula Si(Y)₄, wherein:

each Y is independently R^{D}, R^{E}, R^{F}, as defined above, or a leaving group, wherein the leaving group is selected from the group consisting of a halogen, a mesylate, a triflate, a tosylate, a fluorosulfonate, an N-bound five or six membered N-heterocyclic ring, an O-bound acetimide radical that is further substituted at a nitrogen atom, an N-bound acetimide radical that is optionally further substituted at an oxygen atom and/or at an nitrogen atom, an O-bound trifluoroacetimide radical that is further substituted at a nitrogen atom, an N-bound trifluoroacetimide radical that is optionally further substituted at an oxygen atom and/or a nitrogen atom, a dialkylazane, a silylalkylazane, or an alkyl-, allyl- or aryl sulfonate.

“An N-bound five or six membered N-heterocyclic ring” includes but is not limited to a pyridine (i.e., a pyridinium radical cation), N-bound substituted pyridine (i.e., substituted pyridinium radical cation, including but not limited to p-N,N-dialkylamino pyridinium radical cation), imidazole, and a 1-methyl-3λ2-imidazol-1-ium radical cation.

Suitable silicon-based functionalization agents include but are not limited to monohalosilanes, such as trimethylchlorosilane, dimethylhydrogenchlorosilane, dimethylvinylchlorosilane, trimethylbromosilane, dimethylhydrogenbromosilane, dimethylvinylbromosilane, trimethyliodosilane, dimethylhydrogeniodosilane, dimethylvinyliodosilane, dimethylphenylchlorosilane, dimethylphenylbromosilane, dimethylphenyliodosilane, triethylchlorosilane, diethylhydrogenchlorosilane, diethylvinylchlorosilane, triethylbromosilane, diethylhydrogenbromosilane, diethylvinylbromosilane, triethyldiiodosilane, diethylhydrogeniodosilane, diethylvinyliodosilane, diethylphenylchlorosilane, diethylphenylbromosilane, diethylphenyliodosilane, tripropylchlorosilane, dipropylhydrogenchlorosilane, dipropylvinylchlorosilane, tripropylbromosilane, dipropylhydrogenbromosilane, dipropylvinylbromosilane, tripropyldiiodosilane, dipropylhydrogeniodosilane, dipropylvinyliodosilane, dipropylphenylchlorosilane, dipropylphenylbromosilane, dipropylphenyliodosilane, hexenyldimethylchlorosilane, hexenyldimethylbromosilane, hexenyldimethyliodosilane, hexenylphenylmethyldichlorosilane, hexenylphenylmethylbromosilane, hexenylphenylmethyliodosilane, phenyldihydrogenchlorosilane, phenyldihydrogeniodosilane, phenyldihydrogenbromosilane, diphenylhydrogenchlorosilane, diphenylhydrogeniodosilane, diphenylhydrogenbromosilane, and mixtures thereof.

Suitable silicon-based functionalization agents further include but are not limited dihalosilanes, such as dimethyldichlorosilane, methylhydrogendichlorosilane, methylvinyldichlorosilane, dimethyldibromosilane, methylhydrogendiiodosilane, methylvinyldiiodosilane, methylphenyldichlorosilane, methylphenyldibromosilane, methylphenyldiiodosilane, methylhydrogenchloroiodosilane, dimethylchloroiodosilane, methylvinylchloroiodosilane, methylphenylchloroiodosilane, diethyldichlorosilane, ethylhydrogendichlorosilane, ethylvinyldichlorosilane, diethyldibromosilane, ethylhydrogendibromosilane, ethylviniyldibromosilane, diethyldiiodosilane, ethylhydrogendiiodosilane, ethylvinyldiiodosilane, ethylphenyldichlorosilane, ethylphenyldibromosilane, ethylphenyldiiodosilane, ethylhydrogenchloroiodosilane, diethylchloroiodosilane, ethylvinylchloroiodosilane, ethylphenylchloroiodosilane, dipropyldichlorosilane, propylhydrogendichlorosilane, propylvinyldichlorosilane, dipropyldibromosilane, propylhydrogendibromosilane, propylvinyldibromosilane, dipropyldiiodosilane, propylhydrogendiiodosilane, propylvinyldiiodosilane, propylphenyldichlorosilane, propylphenyldibromosilane, propylphenyldiiodosilane, propylhydrogenchloroiodosilane, dipropylchloroiodosilane, propylvinylchloroiodosilane, propylphenylchloroiodosilane, hexenylmethyldichlorosilane, hexenylmethyldibromosilane, hexenylmethyldiiodosilane, hexenylphenyldichlorosilane, hexenylphenyldibromosilane, hexenylphenyldiiodosilane, hexenylmethylchloroiodosilane, hexenylphenylchloroiodosilane, phenylhydrogendichlorosilane, phenylhydrogendiiodosilane, phenylhydrogendibromosilane, and mixtures thereof.

Suitable silicon-based functionalization agents further include but are not limited to the following, which may include those listed above:

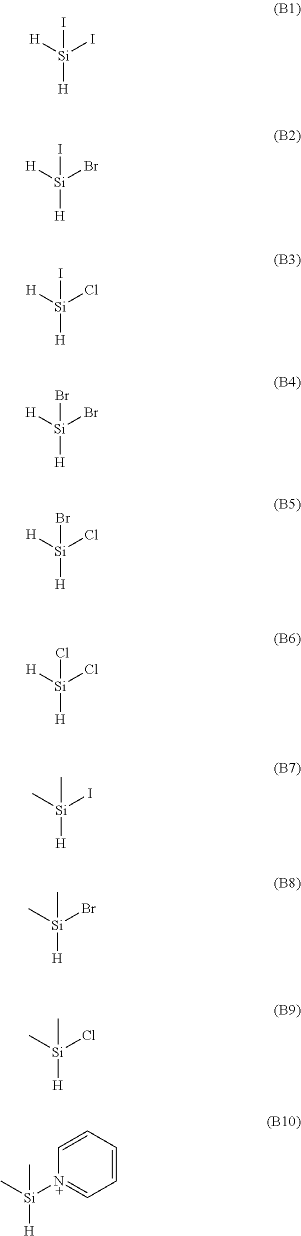

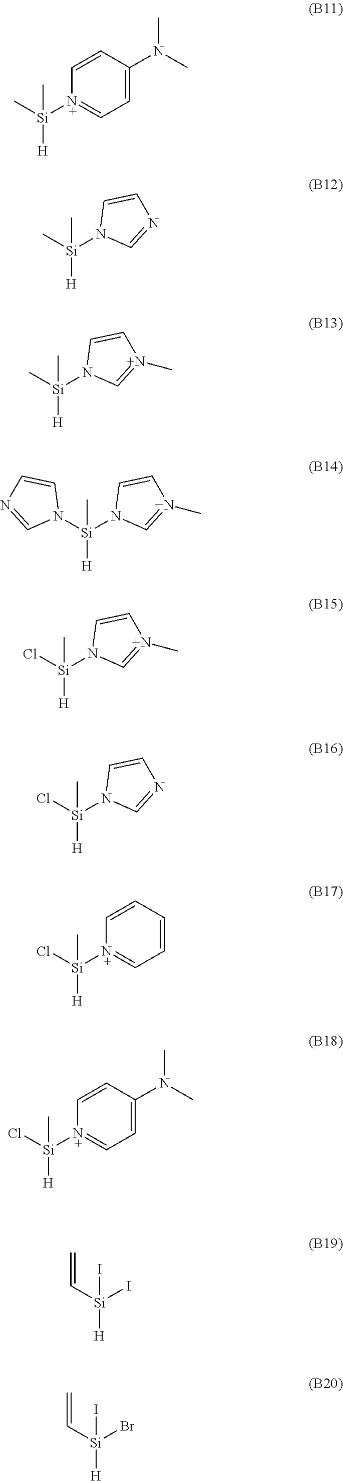

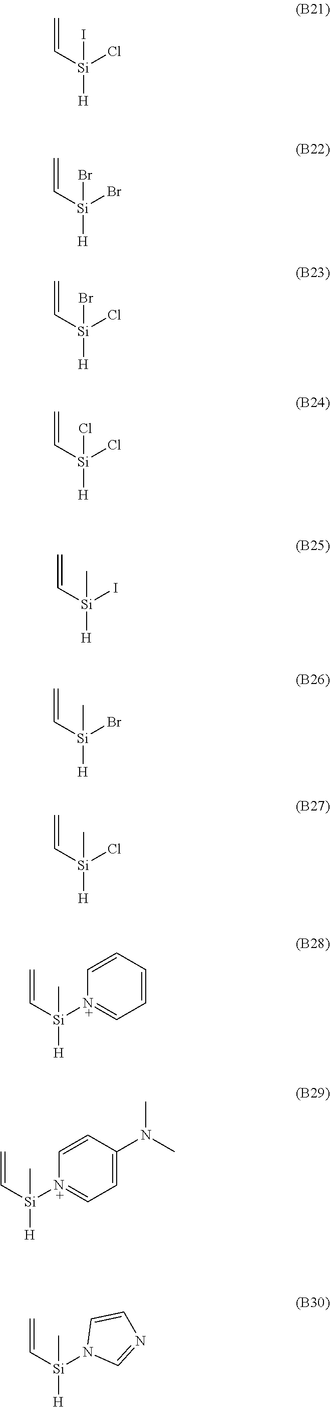

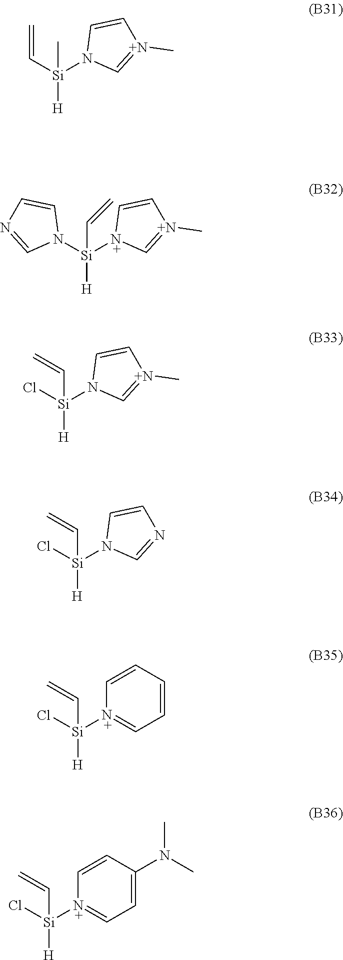

In certain embodiments, the (B) silicon-based functionalization agent is a halosilane. In further embodiments, the (B) silicon-based functionalization agent is an iodosilane, such as dimethylhydrogeniodosilane. In certain embodiments, the (B) silicon-based functionalization agent is a chlorosilane selected from the group consisting of dimethylhydrogenchlorosilane, dimethylvinylchlorosilane, diphenylhydrogenchlorosilane, phenyldihydrogenchlorosilane, phenylhydrogendichlorosilane, and mixtures thereof.

The (B) silicon-based functionalization agent may include any embodiments disclosed herein.

### (C) Nitrogen Containing Heterocycle

Optional starting material (C) is a nitrogen containing heterocycle. In certain embodiments, starting material (C) may be used when the starting material (B) is a halosilane. The nitrogen containing heterocycle may be monocyclic. The nitrogen containing heterocycle may have a saturated, partially unsaturated, or aromatic ring. The nitrogen containing heterocycle may have a general formula selected from the group consisting of:

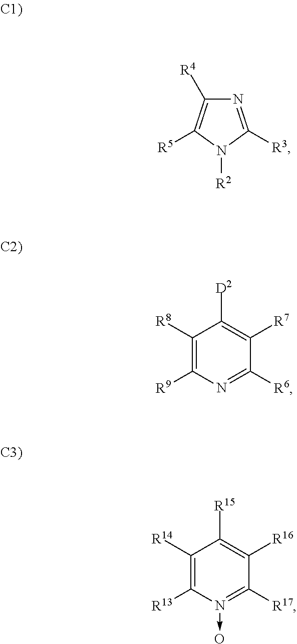

or two or more of C₁), C₂) and C₃), where R² is a monovalent hydrocarbyl group, R³ is a hydrogen atom or a monovalent hydrocarbyl group, R⁴ is a hydrogen atom or a monovalent hydrocarbyl group, R⁵ is a hydrogen atom or a monovalent hydrocarbyl group, R⁶ is a hydrogen atom or a monovalent hydrocarbyl group, R⁷ is a hydrogen atom or a monovalent hydrocarbyl group, R⁸ is a hydrogen atom or a monovalent hydrocarbyl group, R⁹ is a hydrogen atom or a monovalent hydrocarbyl group, and D² is an amino functional hydrocarbyl group or group of formula —NR¹¹₂, where each R¹¹ is a monovalent hydrocarbyl group, R¹³ is a hydrogen atom or a monovalent hydrocarbyl group, R¹⁴ is a hydrogen atom or a monovalent hydrocarbyl group, R¹⁵ is a hydrogen atom or a monovalent hydrocarbyl group, R¹⁶ is a hydrogen atom or a monovalent hydrocarbyl group, and R¹⁷ is a hydrogen atom or a monovalent hydrocarbyl group. Suitable hydrocarbyl groups for R² to R¹⁷ may have 1 to 12 carbon atoms, alternatively 1 to 8 carbon atoms, alternatively 1 to 4 carbon atoms, and alternatively 1 to 2 carbon atoms. Alternatively, the hydrocarbyl groups for R² to R¹⁷ may be alkyl groups. The alkyl groups are exemplified by methyl, ethyl, propyl (including branched and linear isomers thereof), butyl (including branched and linear isomers thereof), and hexyl; alternatively methyl. Alternatively, each R³ to R¹⁰ may be selected from the group consisting of hydrogen and methyl. Alternatively, each R¹³ to R¹⁷ may be hydrogen.

The nitrogen containing heterocycle used in the process described herein may be selected from the group consisting of:

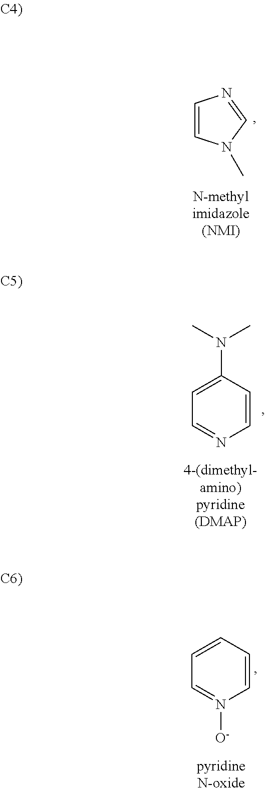

and mixtures of two or more of C₄), C₅), and C₆).

### (D) Solvent

Starting material (D) a solvent may optionally be used in step 1) of the process described above. The solvent may be a hydrocarbon solvent such as an aromatic solvent or an isoparaffinic hydrocarbon solvent. Suitable solvents include but are not limited to a non-polar aliphatic or aromatic hydrocarbon solvent selected from the group of pentane, hexane, heptane, octane, nonane, decane, undecane, dodecane, cyclopentane, methylcyclopentane, cyclohexane, methylcyclohexane, cycloheptane, cyclooctane, decalin, benzene, toluene, xylene, an isoparaffinic fluid including but not limited to Isopar™ E, Isopar™ G, Isopar™ H, Isopar™ L, Isopar™ M, a dearomatized fluid including but not limited to Exxsol™ D or isomers and mixtures of two or more thereof. Alternatively, the solvent may be toluene and/or Isopar™ E.

### Telechelic Polyolefin Product

The present process described here results in a telechelic polyolefin having at least one silicon atom on both terminal ends. More specifically, the present process results in a silicon-terminated telechelic polyolefin composition comprising a compound of formula (I):

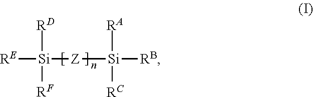

wherein:

Z is a substituted or unsubstituted divalent C₁ to C₂₀ hydrocarbyl group that is linear, branched, or cyclic;

subscript n is a number from 13 to 100,000;

R^{A}, R^{B}, R^{C}, R^{D}, R^{E}, and R^{F} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

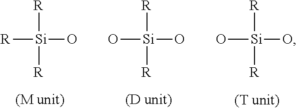

wherein each R is independently a hydrogen atom, a substituted or unsubstituted C₁ to C₁₀ monovalent hydrocarbyl group that is linear, branched, or cyclic, a vinyl group, or an alkoxy group;

two or all three of R^{A}, R^{B}, and R^{C} may optionally be bonded together to form a ring structure when two or all three of R^{A}, R^{B}, and R^{C} are each independently one or more siloxy units selected from D and T units; and

two or all three of R^{D}, R^{E}, and R^{F} may optionally be bonded together to form a ring structure when two or all three of R^{D}, R^{E}, and R^{F} are each independently one or more siloxy units selected from D and T units.

In certain embodiments, subscript n may be a number from 13 to 75,000, from 13 to 50,000, from 13 to 25,000, from 13 to 15,000, from 13 to 10,000, from 13 to 5,000, from 13 to 2,500, from 13 to 1,000, from 20 to 1,000, or from 30 to 1,000. In certain embodiments, Z is an unsubstituted divalent C₁ to C₂₀ hydrocarbyl group that is linear or branched. In further embodiments, at least one of R^{A}, R^{B}, and R^{C} is a hydrogen atom or a vinyl group. In further embodiments, at least one of R^{D}, R^{E}, and R^{F} is a hydrogen atom or a vinyl group. In further embodiments, at least two of R^{A}, R^{B}, and R^{C} are each a methyl group. In further embodiments, at least two of R^{D}, R^{E}, and R^{F} are each a methyl group.

Examples of the —SiR^{A}R^{B}R^{C} and —SiR^{D}R^{E}R^{F} groups of the compound of formula (I) include but are not limited to the following, where the squiggly line [symbol] denotes the attachment of the group to the Z group of the compound of formula (I).

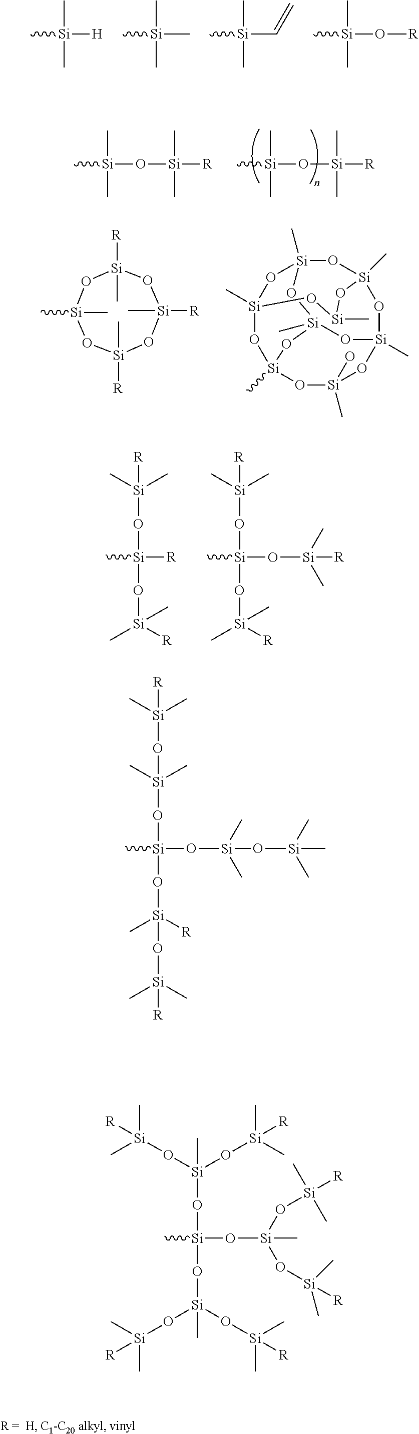

### INDUSTRIAL APPLICABILITY

The present disclosures and below examples show inventive processes for preparing inventive silicon-terminated telechelic polyolefins. These inventive silicon-terminated telechelic polyolefins can be used in a variety of commercial applications, including facilitation of further functionalization or preparation of subsequent polymers.

### Definitions

All references to the Periodic Table of the Elements refer to the Periodic Table of the Elements published and copyrighted by CRC Press, Inc., 1990. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight and all test methods are current as of the filing date of this disclosure. For purposes of United States patent practice, the contents of any referenced patent, patent application or publication are incorporated by reference in their entirety (or its equivalent U.S. version is so incorporated by reference in its entirety), especially with respect to the disclosure of synthetic techniques, product and processing designs, polymers, catalysts, definitions (to the extent not inconsistent with any definitions specifically provided in this disclosure), and general knowledge in the art.

Number ranges in this disclosure are approximate and, thus, may include values outside of the ranges unless otherwise indicated. Number ranges include all values from and including the lower and the upper values, including fractional numbers or decimals. The disclosure of ranges includes the range itself and also anything subsumed therein, as well as endpoints. For example, disclosure of a range of 1 to 20 includes not only the range of 1 to 20 including endpoints, but also 1, 2, 3, 4, 6, 10, and 20 individually, as well as any other number subsumed in the range. Furthermore, disclosure of a range of, for example, 1 to 20 includes the subsets of, for example, 1 to 3, 2 to 6, 10 to 20, and 2 to 10, as well as any other subset subsumed in the range.

Similarly, the disclosure of Markush groups includes the entire group and also any individual members and subgroups subsumed therein. For example, disclosure of the Markush group a hydrogen atom, an alkyl group, an alkenyl group, or an aryl group, includes the member alkyl individually; the subgroup hydrogen, alkyl and aryl; the subgroup hydrogen and alkyl; and any other individual member and subgroup subsumed therein.

In the event the name of a compound herein does not conform to the structural representation thereof, the structural representation shall control.

The term “comprising” and derivatives thereof means including and is not intended to exclude the presence of any additional component, starting material, step or procedure, whether or not the same is disclosed therein.

The terms “group,” “radical,” and “substituent” are also used interchangeably in this disclosure.

The term “hydrocarbyl” means groups containing only hydrogen and carbon atoms, where the groups may be linear, branched, or cyclic, and, when cyclic, aromatic or non-aromatic.

The term “substituted” means that a hydrogen group has been replaced with a hydrocarbyl group, a heteroatom, or a heteroatom containing group. For example, methyl cyclopentadiene (Cp) is a Cp group substituted with a methyl group and ethyl alcohol is an ethyl group substituted with an —OH group.

“Catalyst precursors” include those known in the art and those disclosed in WO 2005/090426, WO 2005/090427, WO 2007/035485, WO 2009/012215, WO 2014/105411, U.S. Patent Publication Nos. 2006/0199930, 2007/0167578, 2008/0311812, and U.S. Pat. Nos. 7,355,089 B2, 8,058,373 B2, and 8,785,554 B2, all of which are incorporated herein by reference in their entirety. The terms “transition metal catalysts,” “transition metal catalyst precursors,” “catalysts,” “catalyst precursors,” “polymerization catalysts or catalyst precursors,” “procatalysts,” “metal complexes,” “complexes,” “metal-ligand complexes,” and like terms are to be interchangeable in the present disclosure.

“Co-catalyst” refers to those known in the art, e.g., those disclosed in WO 2005/090427 and U.S. Pat. No. 8,501,885 B2, that can activate the catalyst precursor to form an active catalyst composition. “Activator” and like terms are used interchangeably with “co-catalyst.”

The term “catalyst system,” “active catalyst,” “activated catalyst,” “active catalyst composition,” “olefin polymerization catalyst,” and like terms are interchangeable and refer to a catalyst precursor/co-catalyst pair. Such terms can also include more than one catalyst precursor and/or more than one activator and optionally a co-activator. Likewise, these terms can also include more than one activated catalyst and one or more activator or other charge-balancing moiety, and optionally a co-activator.

The terms “polymer,” “polymer,” and the like refer to a compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, homogeneous, heterogeneous, etc.

“Interpolymer” and “copolymer” refer to a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

### Examples

### Methods

¹H NMR: ¹H NMR spectra are recorded on a Bruker AV-400 spectrometer at ambient temperature. ¹H NMR chemical shifts in benzene-d₆ are referenced to 7.16 ppm (C₆D₅H) relative to TMS (0.00 ppm).

¹³C NMR: ¹³C NMR spectra of polymers are collected using a Bruker 400 MHz spectrometer equipped with a Bruker Dual DUL high-temperature CryoProbe. The polymer samples are prepared by adding approximately 2.6 g of a 50/50 mixture of tetrachloroethane-dilorthodichlorobenzene containing 0.025M chromium trisacetylacetonate (relaxation agent) to 0.2 g of polymer in a 10 mm NMR tube. The samples are dissolved and homogenized by heating the tube and its contents to 150° C. The data is acquired using 320 scans per data file, with a 7.3 second pulse repetition delay with a sample temperature of 120° C.

GC/MS: Tandem gas chromatography/low resolution mass spectroscopy using electron impact ionization (EI) is performed at 70 eV on an Agilent Technologies 6890N series gas chromatograph equipped with an Agilent Technologies 5975 inert XL mass selective detector and an Agilent Technologies Capillary column (HP1MS, 15 m×0.25 mm, 0.25 micron) with respect to the following:

### Programed Method:

| | |
|---|---|
| Oven Equilibration Time | 0.5 min |
| 50° C. for | 0 min |
| then 25° C./min to 200° C. for | 5 min |
| Run Time | 11 min |

GPC: The gel permeation chromatographic system consists of either a Polymer Laboratories Model PL-210 or a Polymer Laboratories Model PL-220 instrument. The column and carousel compartments are operated at 140° C. Three Polymer (Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards are purchased from Polymer Laboratories (Shropshire, UK). The polystyrene standards are prepared at 0.025 grams in 50 milliliters of solvent for molecular weights equal to or greater than 1,000,000 and 0.05 grams in 50 milliliters of solvent for molecular weights less than 1,000,000. The polystyrene standards are dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let., 6, 621 (1968)): M_{polyethylene}=0.431 (M_{polystyrene}). Polyethylene equivalent molecular weight calculations are performed using Viscotek TriSEC software Version 3.0.

Molecular Weight: Molecular weights are determined by optical analysis techniques including deconvoluted gel permeation chromatography coupled with a low angle laser light scattering detector (GPC-LALLS) as described by Rudin, A., “Modern Methods of Polymer Characterization”, John Wiley & Sons, New York (1991) pp. 103-112.

Unless noted otherwise, all starting materials of the examples described below are commercially available from, for example, Sigma-Aldrich and Gelest.

The starting material 7-octenyldimethylvinylsilane or dimethyhoct-7-en-1-yl)(vinyl)silane used in the examples below is prepared according to Reaction Scheme X and as follows. In a glovebox under nitrogen atmosphere, a 250 mL flask is charged with SilylChloride (3.13 ml, 12.21 mmol) in anhydrous THF 25 mL. 1M VinylMgBr in THF (8 ml) is then added slowly over 10 minutes (temperature increased to 22.8° C., internal monitoring using thermocouple). The second portion of the 1M VinylMgBr in THF (8 ml) is then added slowly over 10 minutes (temperature increased to 25° C.). The reaction is then stirred for 16 h. After this time, the flask is removed from the glove box and the reaction mixture is quenched with sat. aq. NaHCO₃ (10 mL, first few drops added slowly as gas evolved) then water (10 mL) is added. The mixture is transferred to a separatory funnel, Et2O is added (30 mL), the layers are separated, and the organic phase is further washed with sat. aq. NaHCO₃ (10 mL), water (10 mL), brine (10 mL), dried (Na2SO4), filtered, then concentrated to dryness. The concentrate is passed through a plug of silica gel, eluting with hexanes (40 mL). This solution is concentrated to dryness then taken into the glovebox. The product is taken up in hexanes (8 mL) then anhydrous Na2SO4 is added. The solution is filtered through a fritted funnel into a 40 mL vial. The Na2SO4 is further extracted with hexanes (2×4 mL). The hexanes are removed under reduced pressure to provide 2.3 g (95.9%) of product as a colorless liquid.

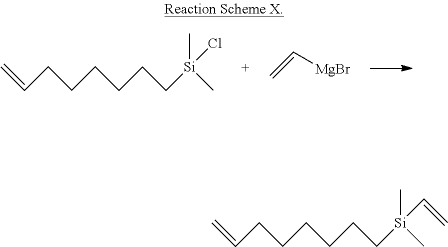

### Preparation of (A) Silicon-terminated Organo-metal Compounds

The following are different synthetic routes for preparing exemplary, non-limiting silicon-terminated organo-metal compounds of the present disclosure.

### Route 1—Synthesis via hex-5-en-1-yldimethylsilane

Step 1: Synthesis of hex-5-en-1-yldimethylsilane. The synthesis of hex-5-en-1-yldimethylsilane is depicted in Reaction Scheme 1 and is as follows. In a nitrogen-filled glovebox, 6-bromo-1-hexene (10.70 g, 65.62 mmol), Mg (1.71 g, 71.25 mmol), and dry THF (62.00 g) are weighed and added into a glass jar. After stirring at room temperature for about 2-5 minutes, the reaction initiates with an observable exotherm (slight boiling of THF) without need for activation of Mg. The reaction mixture is then stirred at room temperature for 1 hour, after which this mixture is filtered using a syringe fitted with a 0.45 μm filter. Chlorodimethylsilane (6.20 g, 65.53 mmol) is then slowly pipetted into the filtrate at room temperature. After stirring the reaction mixture at room temperature overnight, the jar is taken out of the glovebox and the reaction mixture is concentrated using a rotary evaporator. The crude product containing hex-5-en-1-yldimethylsilane is slowly quenched with water and extracted with diethylether, dried with sodium sulfate, passed through a silica plug, and concentrated to give 10.30 g of clear oil. The oil is distilled at room temperature (˜30 torr) to give 7.10 g as colorless oil.

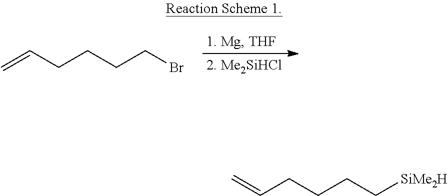

Step 2: Synthesis of bis(hexyldimethylsilane)zinc. The synthesis of an exemplary, non-limiting silicon-terminated organo-metal compound of the present disclosure is depicted in Reaction Scheme 2 and is as follows. In a nitrogen-filled glovebox, a vial is charged with triethylborane (2.35 g, 24.00 mmol) and a borane-dimethylsulfide complex (0.91 g, 12.00 mmol). The mixture is stirred at room temperature for 30 min after which it is transferred to a vial containing the hex-5-en-1-yldimethylsilane (5.1 g, 36.00 mmol) prepared in Step 1, and the mixture is stirred at room temperature until complete disappearance of the silane olefinic peaks (by ¹H NMR). The mixture is subjected to vacuum (1 hour) after which diethyl zinc (4.40 g, 36.00 mmol) is added, and the reaction is stirred at room temperature overnight. The mixture has silvery-gray solids and is filtered using a syringe fitted with a 0.45 μm filter such that excess diethyl zinc is removed under vacuum to give 5.70 g of crude product, which is found to contain residual diethyl zinc (by NMR). The mixture is heated first to 50° C. under vacuum overnight and then at 60° C. overnight to remove all residual diethylzinc and to convert any mono-(hexylsilane)ethylzinc to bis(hexyldimethylsilane)zinc. The silvery-gray solids are observed every time the product is concentrated under vacuum at room temperature, so filtration is done each time using a syringe fitted with a 0.45 μm filter. The final product (3.50 g, colorless oil after filtration) containing the exemplary silicon-terminated organo-metal compound is placed in a dry vial, taped and stored in the glovebox freezer. ¹H NMR (400 MHz, Benzene-d6) δ 4.16-3.96 (m, 1H), 1.59-1.48 (m, 2H), 1.40-1.25 (m, 7H), 0.59-0.48 (m, 2H), 0.27 (t, J=7.6 Hz, 2H). ¹³C NMR (101 MHz, Benzene-d6) δ 36.27, 33.24, 26.33, 24.50, 16.02, 14.18, 14.13, −4.66, −4.68, −4.69.

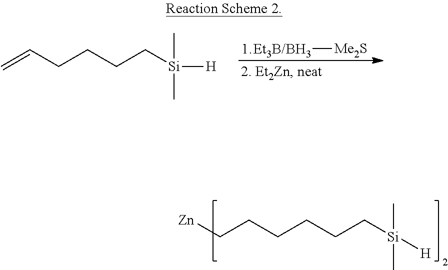

### Route 2—Synthesis via 7-octenyldimethylsilane

The synthesis of another exemplary, non-limiting silicon-terminated organo-metal compound of the present disclosure is depicted in Reaction Scheme 3 and is as follows. The following reactions and manipulations are conducted in a dry, nitrogen-filled glovebox (<1 ppm 02) using oven-dried glassware.

Step 1: To triethylborane (5.8 mL, 40 mmol) in a glass vial is added borane dimethyl sulfide complex (10 M solution, 2.0 mL, 20 mmol). The mixture is stirred at room temperature for 1 hour, then cooled to −30° C. in a freezer. The vial is then removed from the freezer and placed in an aluminum block that had been pre-cooled to −30° C. To the vial is added 7-octenyldimethylsilane (10.02 g, 58.8 mmol) that had been pre-cooled to −30° C. The mixture is stirred at room temperature for 2 hours, and then placed under vacuum for 30 minutes.

Step 2: 7.148 g (30 mmol) of the mixture from Step 1 is added to a glass vial. To the vial is added diethylzinc 3.70 g (30 mmol) and the mixture is stirred at ambient temperature for 2 hours. The mixture is filtered through a 0.45 μm PTFE filter, and the filtrate is stirred under vacuum at ambient temperature for 2 hours, and then under vacuum at 60° C. for 2 hours. The mixture is filtered through a 0.45 μm PTFE filter, and to the filtrate is added diethylzinc (1.23 g, 10 mmol). The mixture is stirred at ambient temperature for 1 hour, and then under vacuum at ambient temperature for 1 hour, then under vacuum at 60° C. for 2 hours, and then under vacuum at 100° C. for 3 hours. The mixture is cooled and filtered through a 0.45 μm PTFE filter, and the colorless filtrate (5.08 g) is stored at −30° C. 1H NMR (400 MHz, C6D6) δ 4.15 (9-tet, 3JHH=3.6 Hz, SiH, 2H), 1.62 (quin, 3JHH=7.0 Hz, ZnCH2CH2, 4H), 1.39 (br, CH2, 20H), 0.6 (br m, SiCH2, 4H), 0.34 (t, 3JHH=7.6 Hz, ZnCH2, 4H), 0.06 (d, 3JHH=3.7 Hz, SiCH3, 12H). 13C NMR (101 MHz, C6D6) δ 37.1, 33.8, 30.1, 30.0, 26.9, 24.9, 16.4, 14.6, −4.3.

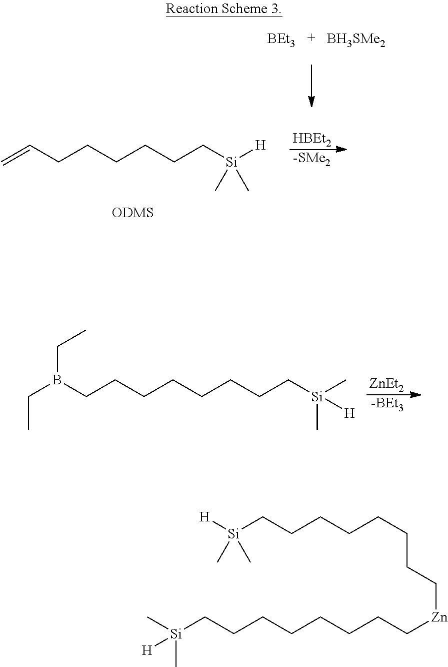

### Route 3—Synthesis Via Catalytic Process

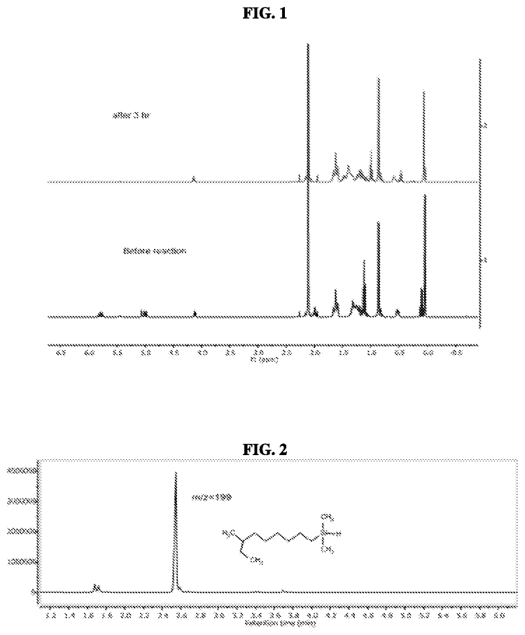

Synthesis of bis(8-(dimethylsilyl)-2-ethyloctyl)zinc: This example is shown in exemplary Reaction Scheme 4 and is as follows. In a nitrogen-filled drybox, 7-octenyldimethylsilane (0.33 g, 1.94 mmol), MAO (0.22 mL of 30 wt % solution in toluene, 0.065 mmol Al), diethylzinc (0.1 mL, 0.97 mmol) and activator [(C₁₆₋₁₈H₃₃₋₃₇)₂CH₃NH] tetrakis(pentafluorophenyl)borate salt (Act. A) available from Boulder Scientific (0.48 mL of 0.064M solution in methylcyclohexane, 0.031 mmol) are added to 3 ml of toluene. Procatalyst (A4) as defined above (PCA in Reaction Scheme 1) (12 mg, 0.026 mmol) is dissolved in 1 mL toluene and added to the mixture to initiate the reaction. After 3 hr, NMR (FIG. 1) shows that the vinyl groups are completely consumed. The remaining peak at 4.2 ppm is believed to be octenylsilane isomers with unreactive internal double bonds. One aliquot is quenched with H₂O for GCMS analysis (FIG. 2) showing a major product peak at 199.2, which is consistent with the expected hydrolyzed product. The small peaks at 1.7 min elution time belong to the unreacted octenylsilane isomers as mentioned.

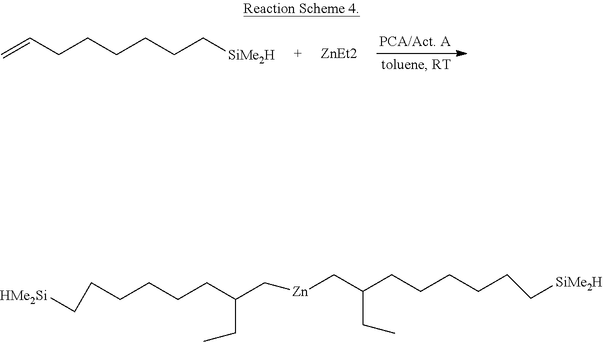

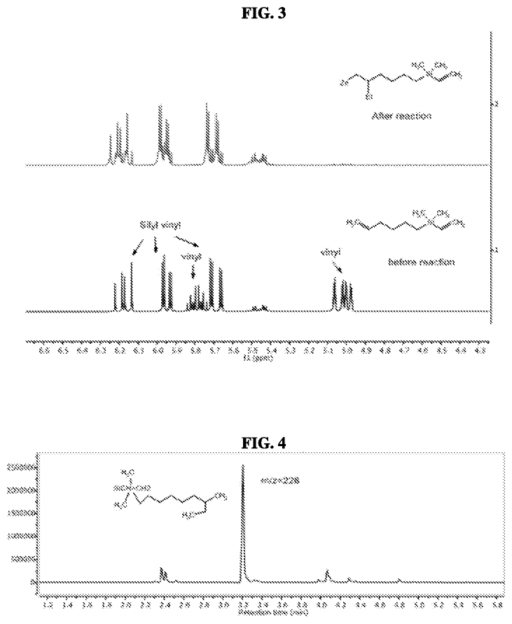

Synthesis of bis(8-(dimethyl(vinyl)silyl)-2-ethyloctyl)zinc: This example is shown in exemplary Reaction Scheme 5 and is as follows. In the drybox under nitrogen atmosphere, 7-octenyldimethylvinylsilane (0.38 g, 1.94 mmol), diethylzinc (0.1 mL, 0.97 mmol) and Act. A (0.48 mL of 0.064M solution in methylcyclohexane, 0.031 mmol) are added to 3 ml of toluene. PCA (Procatalyst (A4) as defined above) (12 mg, 0.026 mmol) is dissolved in 0.5 mL toluene and added to initiate the reaction. After 1.5 hr, NMR (FIG. 3) shows that the olefinic vinyl groups were completely consumed while the silylvinyl groups remained. The remaining peak at 4.2 ppm is believed to be octenylsilane isomers with unreactive internal double bonds. One aliquot is quenched with H₂O for GCMS analysis (FIG. 4) showing a major product peak at m/z of 226, which is consistent to the molecular weight of the expected hydrolyzed product. The small peaks at 2.4 min elution time were believed to be the unreacted octenylsilane isomers with internal or vinylidene double bonds.

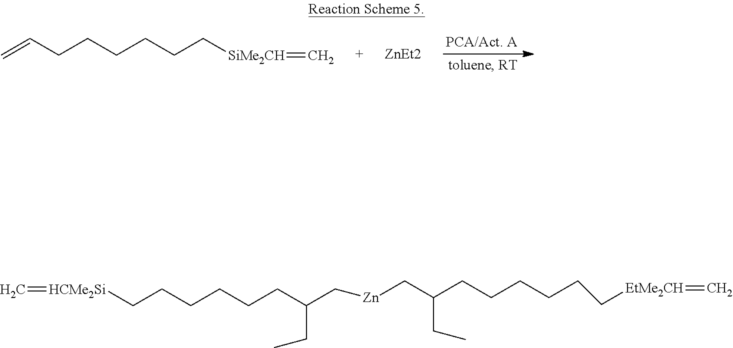

### Route 4—Synthesis Via Heating

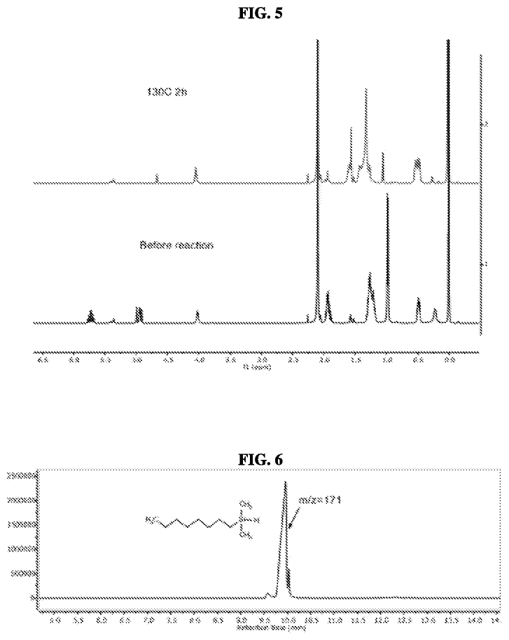

Synthesis of tris(8-dimethylsilyloctyl)aluminum: This example is shown in Reaction Scheme 6 and is as follows. In a nitrogen-filled drybox, 7-octenyldimethylsilane (4.05 g, 23.78 mmol) and triisobutylaluminum (2.0 mL, 7.9 mmol) are mixed in 10 mL of p-xylene in a 40 mL glass vial with a stirbar and a venting needle on the cap. The mixture is heated to and held at 130° C. for 2 h with stirring. After 2 h, NMR (FIG. 5) shows that all vinyl groups disappeared. GCMS analysis (FIG. 6) of a hydrolyzed sample shows a major peak at m/z of 171, which is consistent to the expected reaction product.

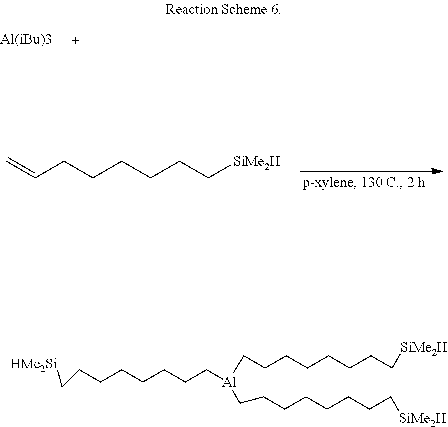

### Polymerization of (A) Silicon-Terminated Organo-Metal Compounds

As detailed below, the exemplary, non-limiting silicon-terminated organo-metal compounds prepared by Routes 1 and 2 discussed above are subject to subsequent batch reactor polymerization.

General Batch Reactor Procedure: Batch reactor polymerizations are conducted in a 2 L PARR batch reactor. The reactor is heated by an electrical heating mantle and is cooled by an internal serpentine cooling coil containing cooling water. Both the reactor and the heating/cooling system are controlled and monitored by a CAMILE TG process computer. The bottom of the reactor is fitted with a dump valve, which empties the reactor contents into a stainless steel dump pot. The dump pot is vented to a 30 gal. blow-down tank, with both the pot and the tank purged with nitrogen. All solvents used for polymerization or catalyst makeup are run through solvent purification columns to remove any impurities that may affect polymerization. The 1-octene, ISOPAR-E, and toluene are passed through two columns, the first containing A2 alumina, the second containing Q5. (ISOPAR E is an isoparaffin fluid, typically containing less than 1 ppm benzene and less than 1 ppm sulfur, which is commercially available from ExxonMobil Chemical Company.) The ethylene is passed through 2 columns, the first containing A204 alumina and 4 Å mol sieves, the second containing Q5 reactant. The N2, used for transfers, is passed through a single column containing A204 alumna, 4 Å mol sieves and Q5.

The desired amount of ISOPAR-E and/or toluene solvent and/or 1-octene is added via shot tank to the load column, depending on desired reactor load. The load column is filled to the load set points by use of a lab scale to which the load column is mounted. After liquid feed addition, the reactor is heated up to the polymerization temperature set point. If ethylene is used, it is added to the reactor when at reaction temperature to maintain reaction pressure set point. Ethylene addition amounts are monitored by a micro-motion flow meter.

The scavenger, MMAO-3A, is handled in an inert glove box, drawn into a syringe and pressure transferred into the catalyst shot tank. This is followed by 3 rinses of toluene, 5 mL each, before being injected into the reactor. The chain-shuttling agent is handled in an inert glove box, drawn into a syringe and pressure transferred into the catalyst shot tank. This is followed by 3 rinses of toluene, 5 mL each, before being injected into the reactor. The procatalyst and activators are mixed with the appropriate amount of purified toluene to achieve a desired molarity solution. The catalyst and activators are handled in an inert glove box, drawn into a syringe and pressure transferred into the catalyst shot tank. This is followed by 3 rinses of toluene, 5 mL each. Immediately after catalyst addition the run timer begins. If ethylene is used, it is then added by the CAMILE to maintain reaction pressure set point in the reactor. These polymerizations are either run for 10 min., or a targeted ethylene uptake. The agitator is then stopped and the bottom dump valve opened to empty reactor contents into a clean dump pot that had been stored in a 130° C. oven for greater than 60 minutes prior to use in order to drive off any excess water absorbed by the metal surface. Once the contents of the reactor are emptied into the dump pot, the normal flow of nitrogen inerting is switched to argon, via a ball valve. The argon flows for a calculated period of time to allow five exchanges of the volume of gas in the pot. When the argon inerting is complete, the dump pot is lowered from its fixture, and a secondary lid with inlet and outlet valves is sealed to the top of the pot. The pot is then inerted with argon for an additional five exchanges of gas, via a supply line and inlet/outlet valves. When complete, the valves are closed. The pot is then transferred to a glove box without the contents coming into contact with the outside atmosphere.

Batch Reactor Polymerization Example 1: Using the General Batch Reactor Procedure above, an exemplary ethylene/octene copolymer is prepared via the silicon-terminated organo-metal compound of Route 1 via the following conditions: 120° C., 23 g of initial ethylene loaded, 397 g ISOPAR-E, 115 g 1-octene, 10 umol MMAO-3A, 1.2 eq. of activator to procatalyst. The amount of procatalyst used is adjusted to reach a desired efficiency. The reactor pressure and temperature are kept constant by feeding ethylene during the polymerization and cooling the reactor as needed. The polymerization is performed with bis(hydrogenated tallow alkyl)methylammonium tetrakis(pentafluorophenyl)borate as the activator, [N-[2,6-Bis(1-methylethyl)phenyl]α-[2-(1-methylethyl)-phenyl]-6-(1-naphthalenyl-C2)-2-pyridinemethanaminato]dimethylhafnium as the procatalyst (i.e., Procatalyst (A3) defined above), and bis(8-(dimethylsilyl)hexyl)zinc as the silicon-terminated organo-metal compound. GPC Mₙ: 25,020 per chain, Co-monomer incorporation: 48 wt % 1-octene

Batch Reactor Polymerization Example 2: Using the General Batch Reactor Procedure above, an exemplary polyethylene polymer is prepared via the silicon-terminated organo-metal compound of Route 2 via the following conditions: 120° C., 23 g of initial ethylene loaded, 600 g toluene, 10 umol MMAO-3A, 1.2 eq. of activator to procatalyst. The amount of procatalyst used is adjusted to reach a desired efficiency. The reactor pressure and temperature are kept constant by feeding ethylene during the polymerization and cooling the reactor as needed. The polymerization is performed with bis(hydrogenated tallow alkyl)methylammonium tetrakis(pentafluorophenyl)borate as the activator, bis(N-isobutyl-6-mesitylpyridin-2-amine)dimethylhafnium as the procatalyst (i.e., Procatalyst (A2) as defined above), and bis(8-(dimethylsilyl)octyl)zinc as the silicon-terminated organo-metal compound. ¹H-NMR Mₙ: 1586 per chain, GPC Mₙ: 1310 per chain

### Preparation of Silicon-Terminated Telechelic Polyolefin

Telechelic Example 1: An exemplary, non-limiting silicon-terminated telechelic polyolefin is prepared by using the ethylene/octene copolymer prepared from Batch Reactor Polymerization 1 (termed as “silicon-terminated ethylene/octene polymerylzinc” below). The procedure is as follows and as seen in Reaction Scheme 7. In a glovebox, a solution of a silicon-terminated ethylene/octene polymerylzinc (8.17% wt. in isopar-e, 455 g, 0.730 mmol, 0.5 equiv) is heated to 110° C. N-methylimidazole (0.233 mL, 2.92 mmol, 2.00 equiv) is added, followed by iododimethylsilane (0.543 g, 2.92 mmol, 2.00 equiv). The clear solution becomes cloudy white. The mixture is stirred overnight. The solution is removed from the glovebox, cooled, and cautiously quenched with 100 mL water. The mixture is heated to 100° C. under nitrogen with stirring. After 20 minutes, the aqueous phase is removed by pipet. The washing process is repeated three additional times. Finally, the polymer solution is precipitated by pouring into 2 L of methanol (done in portions). A gooey polymer precipitated, which is collected by filtration and was dried in a vacuum oven. ¹H NMR (500 MHz, CDCl₂CDCl₂) δ 1.57-1.07 (m, 999H), 0.96 (t, J=6.7 Hz, 112H), 0.19-0.06 (m, 12H).

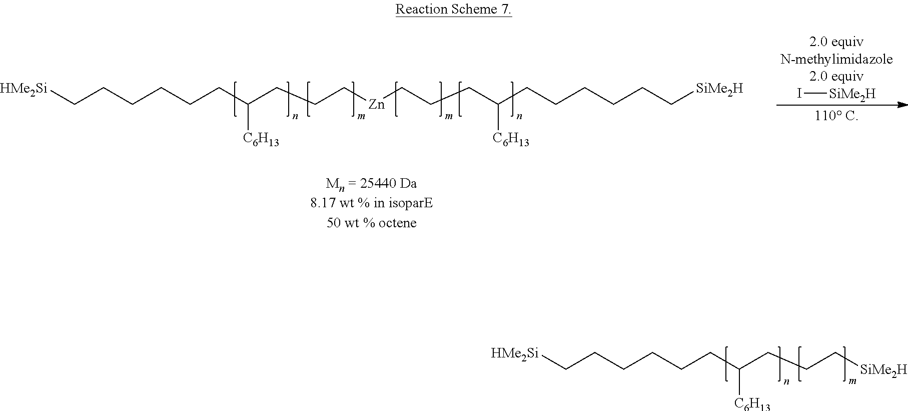

Telechelic Example 2: An exemplary, non-limiting silicon-terminated telechelic polyolefin is prepared by using the polyethylene polymer prepared from Batch Reactor Polymerization 2 (described as “silicon-terminated polymeryl zinc” below). The procedure is as follows and as seen in Reaction Scheme 8.

In a nitrogen-filled glovebox, a 1 L jar with a 4.6 wt % suspension of silicon-terminated polymeryl zinc in isopar-E (1H-NMR Mn: 1586 per chain, GPC Mn: 1310 per chain) is split roughly equally into two 1 L round bottom flasks. Flask one contained 355 g (16.3 g of polymeryl zinc) and flask two contained 379.7 g (17.5 g of polymeryl zinc). Both flasks are heated to 110° C. in the glovebox until the solutions became homogeneous.

Once the solutions become homogeneous, the reagents are added. To flask one is then added 0.91 g of N-methylimidazole (11.1 mmol, 0.88 mL, 1.1 equiv per chain) and 2.2 g of 87% pure iododimethylsilane (17.5 mmol, 1.1 equiv per chain). To flask two is added 0.97 g of N-methylimidazole (11.87 mmol, 0.95 mL, 1.1 equiv per chain) and 2.37 g (11.87 mmol, 1.1 equiv per chain) of 87% pure iododimethylsilane. The flasks are heated at 110° C. for 45 minutes, after which an aliquot was removed for NMR analysis to confirm the disappearance of the C—Zn species. After this is confirmed and a total of 1.5 h of heating, the reaction is cooled to room temperature. The solutions are then each poured into a stirring beaker of methanol (1 L). The precipitate is collected in a disposable plastic fritted filter and dried overnight in a vacuum oven at 40° C.

The precipitate is then transferred to two 1 L round bottom flasks and dissolved in 200 mL of toluene at 110° C. Then, 80 mL of deionized water is added to the flask and stirred vigorously with a reflux condenser and a blanket of nitrogen. After at least 10 minutes of stirring, the stirring is stopped and the two phases are allowed to separate. Using a glass serological pipet, the aqueous layer is removed as much as possible and discarded. This process is repeated three more times for a total of four washings. After the fourth wash, the flasks are cooled to room temperature and precipitated from a stirring solution of methanol (1 L each). The precipitate is washed with methanol and then dried in a vacuum oven at 40° C. overnight.

30.55 g of polymer is isolated (90% yield). Mn by 1H-NMR of the functionalized material including chain ends after accounting for the percentage of dead chains as approximately 1427. The Mn of only the polyethylene segment of functionalized chains is 1307. A signal at 0.97 ppm with triplet multiplicity is attributed to methyl-terminated chain ends that correspond to 13.5% dead chain ends. GPC Mn: 1280, Mw: 1670, and a 1.28.

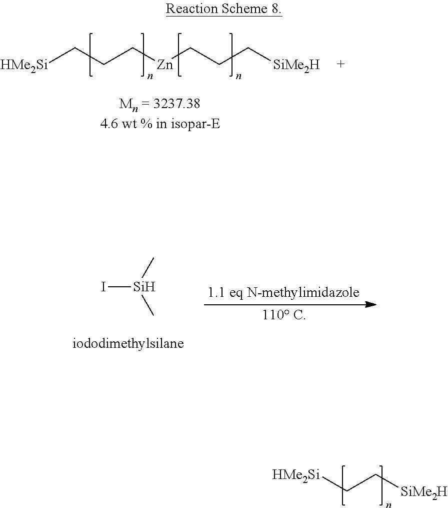

What is claimed is:

1. A silicon-terminated telechelic polyolefin composition comprising a compound of formula (I): 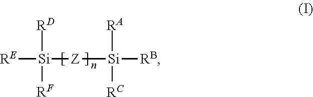
wherein:
Z is a substituted or unsubstituted divalent C₁ to C₂₀ hydrocarbyl group that is linear, branched, or cyclic;
subscript n is a number from 13 to 100,000;
R^{A}, R^{B}, R^{C}, R^{D}, R^{E}, and R^{F} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units: 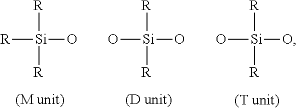
wherein each R is independently a hydrogen atom, a substituted or unsubstituted C₁ to C₁₀ monovalent hydrocarbyl group that is linear, branched, or cyclic, a vinyl group, or an alkoxy group;
two or all three of R^{A}, R^{B}, and R^{C} may optionally be bonded together to form a ring structure when two or all three of R^{A}, R^{B}, and R^{C} are each independently one or more siloxy units selected from D and T units; and
two or all three of R^{D}, R^{E}, and R^{F} may optionally be bonded together to form a ring structure when two or all three of R^{D}, R^{E}, and R^{F} are each independently one or more siloxy units selected from D and T units.

2. The composition of claim 1, wherein Z is an unsubstituted divalent C₁ to C₂₀ hydrocarbyl group that is linear or branched and the subscript n is a number from 30 to 1,000.

3. The composition of claim 1, wherein at least one of R^{A}, R^{B}, and R^{C} is a hydrogen atom or a vinyl group.

4. The composition of claim 1, wherein at least two of R^{A}, R^{B}, and R^{C} are each a methyl group.

5. The composition of claim 1, wherein at least one of R^{D}, R^{E}, and R^{F} is a hydrogen atom or a vinyl group.

6. The composition of claim 1, wherein at least two of R^{D}, R^{E}, and R^{F} are each a methyl group.

7. A process for preparing a silicon-terminated telechelic polyolefin composition, the process comprising (1) combining starting materials comprising:
(A) a silicon-terminated organo-metal compound; and
(B) a silicon-based functionalization agent,
thereby obtaining a product comprising the silicon-terminated telechelic polyolefin composition.

8. The process of claim 7, wherein the starting materials further comprise (C) a nitrogen containing heterocycle and (D) a solvent.

9. The process of claim 7, wherein the (A) silicon-terminated organo-metal compound comprises a compound of formula (II) or (III): 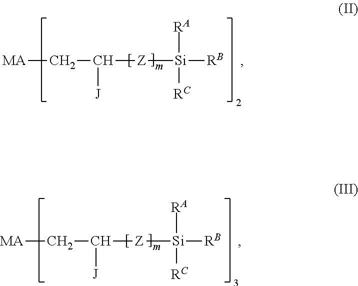
wherein:
MA is a divalent metal selected from the group consisting of Zn, Mg, and Ca;
MB is a trivalent metal selected from the group consisting of Al, B, and Ga;
each Z is independently a substituted or unsubstituted divalent C₁ to C₂₀ hydrocarbyl group that is linear, branched, or cyclic;
each subscript m is a number from 1 to 100,000;
each J is independently a hydrogen atom or a monovalent C₁ to C₂₀ hydrocarbyl group;
each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units: 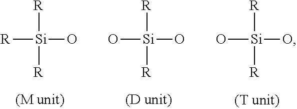
wherein each R is independently a hydrogen atom, a substituted or unsubstituted C₁ to C₁₀ monovalent hydrocarbyl group that is linear, branched, or cyclic, a vinyl group, or an alkoxy group;
two or all three of R^{A}, R^{B}, and R^{C} of one silicon atom may optionally be bonded together to form a ring structure when two or all three of R^{A}, R^{B}, and R^{C} of one silicon atom are each independently one or more siloxy units selected from D and T units.

10. The process of claim 9, wherein:
MA is Zn;
MB is Al;
each Z is independently an unsubstituted divalent C₁ to C₂₀ hydrocarbyl group that is linear or branched;
each subscript m is a number from 1 to 1,000; and
each J is independently a hydrogen atom or an ethyl group.

11. The process of claim 9, wherein at least one of R^{A}, R^{B}, and R^{C} of each silicon atom is a hydrogen atom or a vinyl group.

12. The process of any of claim 9, wherein at least two of R^{A}, R^{B}, and R^{C} of each silicon atom are each a methyl group.

13. The process of any of claim 7, wherein the (B) silicon-based functionalization agent has the formula Si(Y)₄, wherein:
each Y is independently R^{D}, R^{E}, R^{F}, or a leaving group, wherein:
the leaving group is selected from the group consisting of a halogen, a mesylate, a triflate, a tosylate, a fluorosulfonate, an N-bound five or six membered N-heterocyclic ring, an O-bound acetimide radical that is further substituted at a nitrogen atom, an N-bound acetimide radical that is optionally further substituted at an oxygen atom and/or at an nitrogen atom, an O-bound trifluoroacetimide radical that is further substituted at a nitrogen atom, an N-bound trifluoroacetimide radical that is optionally further substituted at an oxygen atom and/or a nitrogen atom, a dialkylazane, a silylalkylazane, or an alkyl-, allyl- or aryl sulfonate; and
R^{D}, R^{E}, and R^{F} are each independently a hydrogen atom, a substituted or unsubstitued C₁ to C₁₀ monovalent hydrocarbyl group that is linear, branched, or cyclic, a vinyl group, an alkoxy group, or one or more siloxy units selected from M, D, and T units: 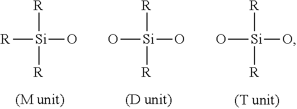
wherein each R is independently a hydrogen atom, a substituted or unsubstituted C₁ to C₁₀ monovalent hydrocarbyl group that is linear, branched, or cyclic, a vinyl group, or an alkoxy group; and
two or all three of R^{D}, R^{E}, and R^{F} may optionally be bonded together to form a ring structure when two or all three of R^{D}, R^{E}, and R^{F} are each independently one or more siloxy units selected from D and T units.

14. The process of claim 13, wherein the (B) silicon-based functionalization agent is a halosilane selected from the group consisting of dimethylhydrogeniodosilane, dimethylvinyliodosilane, diphenylhydrogeniodosilane, phenyldihydrogeniodosilane, phenylhydrogendiiodosilane, dimethylhydrogenchlorosilane, dimethylvinylchlorosilane, diphenylhydrogenchlorosilane, phenyldihydrogenchlorosilane, phenylhydrogendichlorosilane, and mixtures thereof.

15. The process of any of claim 8, wherein the starting materials further comprise a (C) nitrogen containing heterocycle having a general formula selected from: 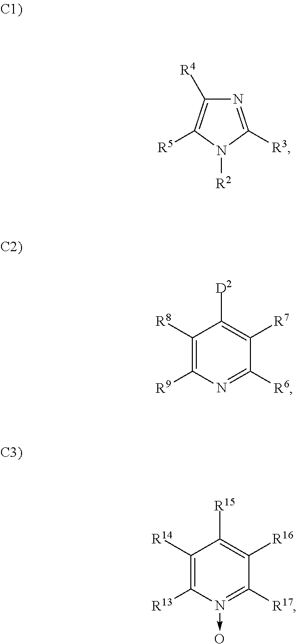
or two or more of C₁), C₂) and C₃), where R² is a monovalent hydrocarbyl group, R³ is a hydrogen atom or a monovalent hydrocarbyl group, R⁴ is a hydrogen atom or a monovalent hydrocarbyl group, R⁵ is a hydrogen atom or a monovalent hydrocarbyl group, R⁶ is a hydrogen atom or a monovalent hydrocarbyl group, R⁷ is a hydrogen atom or a monovalent hydrocarbyl group, R⁸ is a hydrogen atom or a monovalent hydrocarbyl group, R⁹ is a hydrogen atom or a monovalent hydrocarbyl group, and D² is an amino functional hydrocarbyl group or group of formula —NR¹¹₂, where each R¹¹ is a monovalent hydrocarbyl group, R¹³ is a hydrogen atom or a monovalent hydrocarbyl group, R¹⁴ is a hydrogen atom or a monovalent hydrocarbyl group, R¹⁵ is a hydrogen atom or a monovalent hydrocarbyl group, R¹⁶ is a hydrogen atom or a monovalent hydrocarbyl group, and R¹⁷ is a hydrogen atom or a monovalent hydrocarbyl group.

16. The process of claim 15, wherein the (C) nitrogen containing heterocycle is selected from the group consisting of: 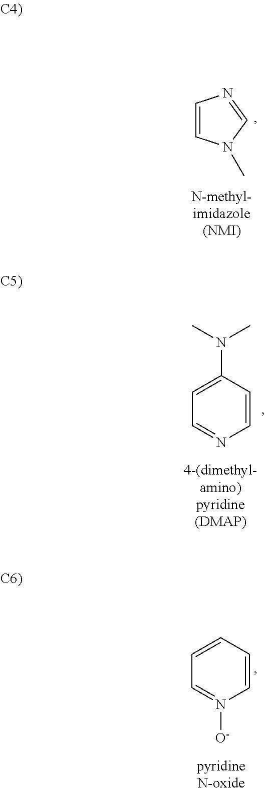
and mixtures of two or more of C₄), C₅), and C₆).
